(19) United States
(12) Patent Application Publication
(10) Pub. No.: US 2017/0277080 A1
(43) Pub. Date: Sep. 28, 2017

(54) ENDLESS BELT FOR IMAGE FORMING APPARATUS, BELT UNIT FOR IMAGE FORMING APPARATUS, IMAGE FORMING APPARATUS, RESIN COMPOSITION, MANUFACTURING METHOD OF ENDLESS BELT FOR IMAGE FORMING APPARATUS, AND MANUFACTURING METHOD OF RESIN COMPOSITION

(71) Applicant: FUJI XEROX CO., LTD., Tokyo (JP)

(72) Inventors: Fumio DAISHI, Ebina-shi (JP); Tomoo MATSUSHIMA, Ebina-shi (JP); Kenji OMORI, Ebina-shi (JP)

(73) Assignee: FUJI XEROX CO., LTD., Tokyo (JP)

(21) Appl. No.: 15/253,333

(22) Filed: Aug. 31, 2016

(30) Foreign Application Priority Data
Mar. 25, 2016 (JP) 2016-062376

(51) Int. Cl. B32B 9/04; G03G 15/01

(52) U.S. Cl. CPC G03G 15/162

(57) ABSTRACT

An endless belt for an image forming apparatus is provided with a resin layer having a sea-island structure including an island part containing a silicone-modified polyetherimide and a sea part containing a polyetherimide other than the silicone-modified polyetherimide and containing carbon black.

### CROSS-REFERENCE TO RELATED APPLICATIONS

This application is based on and claims priority under 35 USC 119 from Japanese Patent Application No. 2016-062376 filed Mar. 25, 2016.

### BACKGROUND

The present invention relates to an endless belt for an image forming apparatus, a belt unit for an image forming apparatus, an image forming apparatus, a resin composition, a manufacturing method of an endless belt for an image forming apparatus, and a manufacturing method of a resin composition.

An image forming apparatus using an electrostatic copying system charges a surface of an electrophotographic photoreceptor, forms an electrostatic latent image with laser beam or the like obtained by modulating an image signal, develops the electrostatic latent image with the charged toner to obtain a visualized toner image, electrostatically transfers a toner image to a recording medium such as a paper or the like, and performing heating and pressurizing so that the image is fixed.

In an image forming apparatus which forms a color image, plural image forming units are disposed in order to individually form a toner image having each color component, the toner images formed by the image forming units are sequentially primarily transferred to an intermediate transfer belt, for example, and superimposed each other, and then, the images are secondarily transferred to a recording medium from the intermediate transfer belt.

Meanwhile, in an image forming apparatus which forms a monochrome image, a system in which a toner image formed on a surface of an electrophotographic photoreceptor is primarily transferred to a transfer belt and then secondarily transferred to a recording medium is used, in addition to a system in which a toner image formed on a surface of an electrophotographic photoreceptor is directly transferred to a recording medium.

### SUMMARY

An aspect of the invention provides an endless belt for an image forming apparatus provided with a resin layer having a sea-island structure including an island part containing a silicone-modified polyetherimide and a sea part containing a polyetherimide other than the silicone-modified polyetherimide and containing carbon black.

### BRIEF DESCRIPTION OF THE DRAWINGS

Exemplary embodiments of the present invention will be described in detail based on the following figures, wherein:

FIG. 1 is a schematic perspective view showing an example of a belt unit according to an exemplary embodiment; and

FIG. 2 is a schematic configuration diagram showing an example of an image forming apparatus according to the exemplary embodiment.

### DETAILED DESCRIPTION

Hereinafter, an exemplary embodiment of the invention will be described in detail.

Endless Belt

An endless belt for an image forming apparatus according to the exemplary embodiment includes a resin layer having a sea-island structure containing an island part containing a silicone-modified polyetherimide and a sea part containing polyetherimide other than the silicone-modified polyetherimide (hereinafter, also simply referred to as “polyetherimide”) and carbon black.

The endless belt according to the exemplary embodiment may be a single-layer endless belt including only the resin layer and may be a laminated endless belt in which one or more other layers are laminated on the resin layer.

By using the configuration described above, the endless belt according to the exemplary embodiment is an endless belt in which generation of foam breaking marks is prevented. The reason thereof is assumed as follows.

First, the resin layer containing polyetherimide has properties having high hardness and has excellent abrasion resistance. Meanwhile, the resin layer tends to have low softness and deteriorated bendability. Particularly, when carbon black is further contained in the resin layer containing polyetherimide, tendency of deteriorated bendability increases. Accordingly, the resin layer containing polyetherimide and carbon black further contains silicone-modified polyetherimide. Accordingly, softness is improved and bending resistance increases.

However, when a resin composition containing polyetherimide, silicone-modified polyetherimide, and carbon black is formed to obtain a resin layer, foam breaking marks may be generated on the resin layer. This is because an acid functional group on the surface of the carbon black causes decomposition of siloxane chains of silicone-modified polyetherimide to generate small bubbles due to the composition, and accordingly foam breaking marks are generated on the resin layer.

Therefore, the resin layer having a sea-island structure containing a sea part containing polyetherimide and carbon black and an island part containing silicone-modified polyetherimide is obtained. Accordingly, a probability of contact between silicone-modified polyetherimide and carbon black is decreased, and the decomposition of siloxane chains of silicone-modified polyetherimide due to the acid functional group on the surface of the carbon black is prevented.

Thus, it is assumed that the endless belt according to the exemplary embodiment becomes an endless belt in which generation of foam breaking marks is prevented, by using the configuration described above. When the endless belt is applied to an intermediate transfer belt of an image forming apparatus, cleaning failure due to foam breaking marks is reduced and image defects caused by the foam breaking marks are prevented.

Hereinafter, a single-layer endless belt will be mainly described as a representative example of the endless belt according to the exemplary embodiment, but the endless belt according to the exemplary embodiment is not limited to a single-layer endless belt.

First, each component contained in the endless belt (resin layer) according to the exemplary embodiment will be described.

The endless belt (resin layer) according to the exemplary embodiment contains polyetherimide, silicone-modified polyetherimide, and carbon black. The endless belt (resin layer) may contain polyester and other components, if necessary.

Polyetherimide

The polyetherimide other than a silicone-modified polyetherimide is a polyetherimide not containing siloxane bonds and is a resin having melt molding properties containing an aliphatic, alicyclic, aromatic ether unit and a cyclic imide group as a repeating unit, for example.

As the polyetherimide, a material obtained by a polymerization reaction between dicarboxylic acid dianhydride containing ether bonds and diamine is used, for example. That is, a polyetherimide having at least a repeating unit structure derived from dicarboxylic acid dianhydride containing ether bonds and diamine is used, for example.

Examples of dicarboxylic acid dianhydride containing ether bonds include 2,2-bis [4-(3,4-dicarboxyphenoxy)phenyl] propane dianhydride, 4,4′-bis (3,4-dicarboxyphenoxy) diphenylether dianhydride, 4,4′-bis (3,4-dicarboxy phenoxy) diphenyl sulfide dianhydride, 4,4′-bis (3,4-dicarboxyphenoxy) benzophenone dianhydride, 4,4′-bis (3,4-dicarboxyphenoxy) diphenyl sulfone dianhydride, 2,2-bis [4-(2,3-dicarboxy phenoxy) phenyl] propane dianhydride, 4,4′-bis (2,3-dicarboxy phenoxy) diphenyl ether dianhydride, 4,4′-bis (2,3-dicarboxy phenoxy) diphenyl sulfide dianhydride, 4,4′-bis (2,3-dicarboxy phenoxy) benzophenone dianhydride, 4,4′-bis (2,3-dicarboxy phenoxy) diphenyl sulfone dianhydride, 4-(2,3-dicarboxy phenoxy)-4′-(3,4-dicarboxyphenoxy) diphenyl-2,2-propane dianhydride, 4-(2,3-dicarboxy phenoxy)-4′-(3,4-dicarboxyphenoxy) diphenyl ether dianhydride, 4-(2,3-dicarboxy phenoxy)-4′(3,4-dicarboxy phenoxy) diphenyl sulfide dianhydride, 4-(2,3-dicarboxy phenoxy)-4′-(3,4-dicarboxyphenoxy) benzophenone dianhydride, and 4-(2,3-dicarboxy phenoxy)-4′-(3,4-dicarboxy phenoxy) diphenyl sulfone dianhydride. These dicarboxylic acid dianhydride may be used alone or may be used in combination of two or more selected from the examples.

Examples of diamine include aliphatic diamine, alicyclic diamine, aromatic diamine, and aromatic diamine containing heterocyclic rings.

There is no particular limitation regarding diamines, as long as diamine is a diamine compound having two amino groups in a molecular structure.

Examples of diamine include aromatic diamines such as p-phenylenediamine, m-phenylenediamine, 4,4′-diaminodiphenylmethane, 4,4′-diaminodiphenyl ethane, 4,4′-diaminodiphenyl ether, 4,4′-diaminodiphenyl sulfide, 4,4′-diamino diphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-amino phenyl)-1,3,3-trimethylindan, 4,4′-diamino benzanilide, 3,5-diamino-3′-trifluoromethyl benzanilide, 3,5-diamino-4′-trifluoromethyl benzanilide, 3,4′-diaminodiphenyl ether, 2,7-diamino fluorene, 2,2-bis (4-aminophenyl) hexafluoropropane, 4,4′-methylene-bis (2-chloroaniline), 2,2′,5,5′-tetrachloro-4,4′-diaminobiphenyl, 2,2′-dichloro-4,4′-diamino-5,5′-dimethoxy biphenyl, 3,3′-dimethoxy-4,4′-aminobiphenyl, 4,4′-diamino-2,2′-bis (trifluoromethyl) biphenyl, 2,2-bis [4-(4-aminophenoxy) phenyl] propane, 2,2-bis [4-(4-aminophenoxy) phenyl] hexafluoropropane, 1,4-bis (4-aminophenoxy) benzene, 4,4-bis (4-aminophenoxy)-biphenyl, 1,3′-bis (4-aminophenoxy) benzene, 9,9-bis (4-aminophenyl) fluorene, 4,4′-(p-phenyleneisopropylidene) bisaniline, 4,4′-(m-phenyleneisopropylidene) bisaniline, 2,2′-bis [4-(4-amino-2-trifluoromethylphenoxy) phenyl] hexafluoropropane, and 4,4′-bis [4-(4-amino-2-trifluoromethyl) phenoxy]-octafluorobiphenyl; aromatic diamines including two amino groups bonded to an aromatic ring and hetero atoms other than nitrogen atoms of the amino groups such as diamino tetraphenylthiophene; and aliphatic diamines and alicyclic diamines such as 1,1-meta-xylylenediamine, 1,3-propanediamine, tetramethylene diamine, pentamethylene diamine, octamethylene diamine, nonamethylene diamine, 4,4-amino heptamethylene diamine, 1,4-diamino cyclohexane, isophorone diamine, tetrahydrodicyclopentadienylene diamine, hexahydro-4,7-methanoindanylene dimethylene diamine, tricyclo [6,2,1,0^{2.7}]-undecylen dimethyldiamine, and 4,4′-methylenebis (cyclohexylamine).

These diamines may be used alone or may be used in combination of two or more selected from the examples.

As a specific example of polyetherimide, a material obtained by causing a reaction between aromatic bis (ether dicarboxylic) acid and organic diamine in an organic solvent at a heating temperature, and examples thereof include a polymer obtained as a fibrous polymer which is obtained by mixing 2,2-bis [4-(2,3-dicarboxy phenoxy) phenyl] propane, 2,2-bis [4-(3,4-dicarboxyphenoxy) phenyl] propane, and 4,4′-diaminodiphenylmethane with each other, causing heating and refluxing by adding the mixture into a phenol•toluene mixed solvent, continuously removing water generated due to the reaction by using azeotropic distillation, and injecting the reaction product mixture into methanol.

For example, ULTEM 1000 series manufactured by Saudi Basic Industries Corporation (SABIC) are used as a commercially available product of polyetherimide.

A melt flow rate of polyetherimide is preferably equal to or higher than 15 g/10 min, more preferably equal to or higher than 20 g/10 min, and even more preferably equal to or higher than 30 g/10 min, from a viewpoint of preventing generation of foam breaking marks.

A value of the melt flow rate of polyetherimide is adjusted by mixing polyetherimide having high molecular weight (for example, ULTEM 1010 or the like) and polyetherimide having ultra-low molecular weight (ULTEM 1040A or the like), for example, and changing a blending ratio thereof.

The melt flow rate (MFR) of polyetherimide is a value measured based on JIS K 7210 under the conditions of 295° C. and loads of 6.6 kgf.

The content of polyetherimide is preferably from 20% by weight to 90% by weight with respect to the entire resin components of the resin layer. When the content of polyetherimide is equal to or greater than 20% by weight, high abrasion resistance is obtained, and when the content of polyetherimide is equal to or smaller than 90% by weight, high bending resistance is obtained.

From such viewpoints, the content of polyetherimide is more preferably from 50% by weight to 90% by weight and particularly preferably from 60% by weight to 90% by weight.

Silicone-Modified Polyetherimide Silicone-modified polyetherimide is

obtained by modifying polyetherimide by using a silicone resin and is polyetherimide having siloxane bonds.

As a specific example of silicone-modified polyetherimide, silicone-modified polyetherimide obtained by modifying polyetherimide described above by using a silicone resin, and examples thereof include a reactant of aromatic bis (ether anhydride) and amine-terminated organosiloxane ad organic diamine.

For example, SILTEM STM 1500, 1600, 1700, and the like manufactured by Saudi Basic Industries Corporation (SABIC) are used as a commercially available product of silicone-modified polyetherimide (a copolymer of a polyetherimide resin and a silicone resin).

Here, as silicone-modified polyetherimide, silicone-modified polyetherimide having a melt flow rate equal to or lower than (or lower than) 15 g/10 min may be used. When this silicone-modified polyetherimide is used, the sea-island structure is easily obtained when the endless belt (resin layer) is formed.

From such viewpoints, the melt flow rate of silicone-modified polyetherimide is preferably equal to or lower than 15 g/10 min and more preferably equal to or lower than 10 g/10 min.

The melt flow rate (MFR) of silicone-modified polyetherimide is a value measured based on JIS K 7210 under the conditions of 295° C. and loads of 6.6 kgf.

As a commercially available product of silicone-modified polyetherimide having a melt flow rate in the range described above, SILTEM STM 1500, 1600, 1700, and the like manufactured by Saudi Basic Industries Corporation (SABIC) are used, for example.

The content of silicone-modified polyetherimide is preferably from 5% by weight to 50% by weight with respect to the entire resin components of the resin layer. When the content of silicone-modified polyetherimide is equal to or greater than 5% by weight, high bending resistance is obtained, and when the content of polyetherimide is equal to or smaller than 50% by weight, high abrasion resistance is obtained.

From such viewpoints, the content of silicone-modified polyetherimide is more preferably from 5% by weight to 50% by weight and particularly preferably from 5% by weight to 40% by weight.

Carbon Black

Examples of carbon black include Ketjen black, oil furnace black, channel black, acetylene black, and carbon black having oxidized surface (hereinafter, referred to as “surface-treated carbon black”). Among these, surface-treated carbon black is preferable, from a viewpoint of electric resistance stability over time.

The surface-treated carbon black is obtained by applying a carboxyl group, a quinone group, a lactone function, or hydroxyl group to the surface thereof. Examples of a method of the surface treatment include an air oxidation method of bringing the surface to contact with air under a high temperature atmosphere to cause a reaction, a method of causing a reaction between nitrogen oxide and ozone at room temperature (for example, 22° C.), and a method of performing air oxidation under high temperature atmosphere and then causing ozone oxidation at a low temperature.

As a particle diameter of carbon black is small, a large number of electrical conduction paths is easily ensured and electrical deterioration (resistance change) is prevented. From such viewpoints, an average primary particle diameter of carbon black may be equal to or smaller than 50 nm, is preferably equal to or smaller than 25 nm, and more preferably equal to or smaller than 20 nm.

A lower limit value of the average primary particle diameter of carbon black is preferably equal to or greater than 10 nm, from a viewpoint of dispersibility of carbon black.

The average primary particle diameter of carbon black is measured by using the following method.

First, the resin layer (endless belt) is cut by using a microtome to collect a measurement sample having a thickness of 100 nm, and the measurement sample is observed by using a transmission electron microscope (TEM). Diameters of equivalent circles in a project area of each of 50 carbon black particles are set as particle diameters, and an average value thereof is set as the average primary particle diameter.

pH of the carbon black may be equal to or smaller than 5, is preferably equal to or smaller than 4.5, and more preferably 4.0, from a viewpoint of electric resistance stability over time.

The content of carbon black depends on the purpose of the endless belt, and is preferably from 10 parts by weight to 30 parts by weight, more preferably from 12 parts by weight to 28 parts by weight, and particularly preferably from 15 parts by weight to 25 parts by weight with respect to 100 parts of the entire resin.

When the content of carbon black is in the range described above, a high density conductive point due to carbon black in the resin layer is obtained and discharge energy applied to the surface of the resin layer is easily dispersed, and thus deterioration is prevented.

Polyester

Polyester causes an operation of decreasing a formation temperature when forming the endless belt (resin layer) (an operation of decreasing a formation temperature to a temperature equal to or lower than 300° C., for example). Accordingly, decomposition of siloxane chains of silicone-modified polyetherimide and volatilization of volatile components of carbon black which occur when forming the endless belt (resin layer) are prevented, by using polyester and decreasing a formation temperature. Therefore, generation of foam breaking marks is further prevented.

Examples of polyester include homo- or co-polyalkylene terephthalate, homo- or polyalkylene naphthalate, and a polyester elastomer. Polyester may be used alone or in combination of two or more kinds thereof.

As homo- or co-polyalkylene terephthalate, homo- or co-polyalkylene terephthalate including a straight, branched, or cyclic alkylene group (preferably straight alkylene group having 2 to 4 carbon atoms) is used, and specifically, polyethylene terephthalate, polybutylene terephthalate is used.

As homo- or polyalkylene naphthalate, homo- or copolyalkylene naphthalate including a straight, branched, or cyclic alkylene group (preferably straight alkylene group having 2 to 4 carbon atoms) is used, and specifically, polyethylene naphthalate, polybutylene naphthalate is used.

Examples of a polyester elastomer include 1) an elastomer including aromatic polyester as a hard segment and aliphatic polyester as a soft segment, and 2) an elastomer including aromatic polyester as a hard segment and an aliphatic polyether as a soft segment.

Examples of aromatic polyester include homo- or co-polyalkylene arylate such as polyalkylene terephthalate or polyalkylene naphthalate.

Examples of aliphatic polyester include polylactone such as poly(ε-caprolactone), polyenantholactone, or polycaprylolactone, and polyalkylene adipate such as polybutylene adipate or polyethylene adipate.

Examples of aliphatic polyether include polyalkylene glycol such as polyethylene oxide, polypropylene oxide, or polytetramethylene oxide.

In a polyester elastomer, a weight ratio of a hard segment and a soft segment (hard segment/soft segment) may be, for example, in a range of 1/99 to 99:1 (preferably in a range of 5/95 to 95/5, more preferably in a range of 25/75 to 75/25).

Among these, as polyester, at least one selected from the group consisting of polyalkylene naphthalate and a polyester elastomer is used. Particularly, when polyalkylene naphthalate is used, heat resistance of the endless belt (resin layer) is easily improved. When a polyester elastomer is used, a compressive elasticity modulus of the endless belt (resin layer) is easily improved.

Among polyesters, as a commercially available product of polyalkylene naphthalate, IQB-OT manufactured by Teijin Limited. is used as polybutylene naphthalate and TEONEX TN8065S manufactured by Teijin Limited. is used as polyethylene naphthalate, for example. As a commercially available product of a polyester elastomer, HYTREL 7277 manufactured by Du Pont-Toray Co., Ltd., or PRIMALLOY A SERIES and B SERIES manufactured by Mitsubishi Chemical Corporation is used, for example.

The content of polyester is preferably from 5% by weight to 60% by weight with respect to the entire resin component of the resin layer. When the content of polyester is in the range described above, decomposition of siloxane chains of silicone-modified polyetherimide and volatilization of volatile components of carbon black which occur when forming the resin layer are prevented, and accordingly, generation of foam breaking marks is more easily prevented.

From such viewpoints, the content of polyester is preferably from 5% by weight to 60% by weight and particularly preferably from 10% by weight to 40% by weight.

Other Components

As other components, an antioxidant, a surfactant, a heat-resistant anti-aging agent, or particularly, a well-known additive to be blended with an endless belt of an image forming apparatus is used.

Next, properties or purpose of the endless belt according to the exemplary embodiment will be described. In a case of applying the endless belt according to the exemplary embodiment as an endless belt of an image forming apparatus, particularly, an intermediate transfer belt, the following characteristics are obtained. The following characteristics of the endless belt according to the exemplary embodiment are shown as values measured by a measurement method of the example which will be described later.

Characteristics

Sea-Island Structure

The endless belt (resin layer) according to the exemplary embodiment has a sea-island structure containing an island part containing a silicone-modified polyetherimide and a sea part containing a polyetherimide other than the silicone-modified polyetherimide and carbon black.

In a case where the endless belt (resin layer) contains polyester and other components, polyester and other components may be contained in the island part.

Here, containing carbon black in the sea part indicates that 90% by weight or more (preferably 95% by weight or more, more preferably 98% by weight or more) carbon black of the entire carbon black is contained in the sea part. It is ideal that all of carbon black is contained in the sea part. Meanwhile, 10% by weight or smaller carbon black (preferably 5% by weight or smaller, more preferably 2% by weight or smaller) of the entire carbon black may be contained in the island part. It is ideal that carbon black is not contained in the island part.

Surface Resistivity

The surface resistivity of the endless belt (resin layer) according to the exemplary embodiment measured by applying a voltage of 100 V in a normal temperature and normal humidity (temperature of 22° C. and humidity of 55% RH) may be from 10⁷ to 10¹³ Ω/□ and more preferably from 10⁸ to 10¹² Ω/□.

Regarding the endless belt (resin layer) according to the exemplary embodiment, a difference between the surface resistivity measured by applying a voltage of 100 V in a normal temperature and normal humidity (temperature of 22° C. and humidity of 55% RH) and the surface resistivity measured by applying a voltage of 500 V in a normal temperature and normal humidity (temperature of 22° C. and humidity of 55% RH) may be equal to or smaller than 10^{1.0} Ω/□ or preferably equal to or smaller than 10^{0.5} Ω/□.

Surface Roughness

The surface roughness Rz of an outer circumferential surface of the endless belt (resin layer) according to the exemplary embodiment may be equal to or smaller than 0.5 μm and preferably equal to or smaller than 0.3 μm, from a viewpoint of preventing generation of image quality defects.

The surface roughness Rz is measured by using a surface roughness state measuring device SURFCOM 1400 manufactured by Tokyo Seimitsu Co., Ltd. with a method based on JIS B0601 (1994). In the measurement conditions, a cut-off length is 0.08 mm, a measurement length is 2.4 mm, and a traverse speed is 0.3 mm/s.

Tensile Elasticity

Tensile elasticity modulus of the endless belt (resin layer) according to the exemplary embodiment may be equal to or greater than 2000 MPa and preferably equal to or greater than 2200 MPa, from a viewpoint of preventing generation of image quality defects due to cleaning failure.

The tensile elasticity modulus is measured based on JIS K7127 (1999) and an average value of values obtained through five times of measurements in a circumferential direction is set as a measurement value. More specifically, a punching test piece (width of 5 mm) of Dumbbell No. 3 is prepared and the measurement thereof is performed at a tension rate of 20 mm/min by using MODEL-1605N manufactured by Aikoh Engineering Co., Ltd.

Compressive Elasticity Modulus

The compressive elasticity modulus of the endless belt (resin layer) according to the exemplary embodiment may be equal to or greater than 2800 MPa and is preferably equal to or greater than 3000 MPa, from a viewpoint of preventing generation of image quality defects due to cleaning failure.

In the measurement method of the compressive elasticity modulus, an endless belt as a measurement target is prepared and an edge surface of a cylindrical member is cut out and set as a measurement sample. The compressive elasticity modulus is measured with an inclination of an SS curve when performing measurement using a microhardness measuring device (product name: PICODENTOR HM500 manufactured by Fischer Instrument) under the following conditions. The compressive elasticity modulus of five portions of the measurement sample is measured and an average value thereof is used.

Environment conditions: 23° C., 55% RH, indenter used: diamond-made triangular pyramid indenter with a ridge line angle of 115°, maximum test load: 0.5 mN, loading rate: 0.025 mN/sec

Bending Resistance

Regarding the endless belt (resin layer) according to the exemplary embodiment, the bending resistance with respect to bending R: 0.38 mm measured based on JIS P8115 (2001) by using MIT folding endurance tester MIT-DA (manufactured by Toyo Seiki Seisaku-Sho) is preferably 300 times or more and more preferably 500 times or more, from a viewpoint of preventing fracture.

Thickness

A thickness of the endless belt (resin layer) according to the exemplary embodiment is not limited and may be selected according to the purpose, and for example, in a case of using the endless belt according to the exemplary embodiment as an intermediate transfer belt of an image forming apparatus, the thickness thereof is preferably from 60 μm to 150 μm.

Purpose

The endless belt according to the exemplary embodiment is suitably used as an intermediate transfer belt in an image forming apparatus, a recording medium transport belt, an endless belt for an image forming apparatus such as a fixed belt.

Manufacturing Method of Endless Belt

The manufacturing method of the endless belt according to the exemplary embodiment is not particularly limited, and the endless belt may be suitably manufactured by extrusion molding.

Specifically, first, polyetherimide, carbon black, and if necessary, other additives are kneaded and mixed with each other with desired blending amounts, and a carbon black-containing resin pellet is obtained. The carbon black-containing resin pellet, silicone-modified polyetherimide, and if necessary, other additives are kneaded and mixed with each other with desired blending amounts, and a resin pellet is obtained.

Then, the obtained pellet is put into an melt extruder to extrude in a cylindrical shape, the diameter thereof is expanded to a target diameter by using a mandrel, and the resultant material is cooled and solidified to obtain a cylindrical compact (cylindrical body). Here, the diameter of the cylindrical body which is cooled (or solidified) to 80° C. or lower is preferably from 0.9 times to 1.1 times of the diameter of the cylindrical body immediately after extrusion.

The obtained cylindrical body is cut to have a target width and the endless belt according to the exemplary embodiment may be obtained. By using this manufacturing method, the endless belt (resin layer) having a sea-island structure is obtained.

In addition, after obtaining a carbon black-containing resin pellet by kneading and mixing polyetherimide, carbon black, and if necessary, other additives with each other with desired blending amounts, the resin pellet, silicone-modified polyetherimide, and if necessary, other additives are mixed with each other with desired blending amounts, this mixture is extruded in a cylindrical shape by using an extruder, cooled and solidified to obtain a cylindrical body. The endless belt (resin layer) having a sea-island structure is also obtained by using this manufacturing method.

As an example of the endless belt according to the exemplary embodiment described above, an endless belt configured with a single layer has been described, but an endless belt may be configured with a laminate of two or more layers, as long as the resin layer is included as an uppermost surface.

Specifically, the endless belt according to the exemplary embodiment is, for example, configured with a laminate of a base layer and a surface layer (surface release layer) on the outer circumferential surface thereof, and the resin layer may be used as at least any one of the base layer and the surface layer. Here, in a case of using the resin layer as the surface layer, a release material (for example, fluorine compound (fluorine resin or particles thereof) or the like) may be blended.

An intermediate layer (for example, elastic layer) may be provided between the base layer and the surface layer, the base layer may be configured with a laminate of two or more layers.

Resin Composition

A resin composition according to the exemplary embodiment is a resin composition having a sea-island structure containing an island part containing a silicone-modified polyetherimide and a sea part containing a polyetherimide other than the silicone-modified polyetherimide and carbon black.

The resin composition according to the exemplary embodiment has the same composition as the resin layer of the endless belt according to the exemplary embodiment described above. Accordingly, a compact (for example, endless belt) in which generation of foam breaking marks is prevented is obtained with the resin composition according to the exemplary embodiment.

Belt Unit

A belt unit for an image forming apparatus according to the exemplary embodiment includes the endless belt according to the exemplary embodiment described above and plural rolls which support the endless belt in a state where tension is applied.

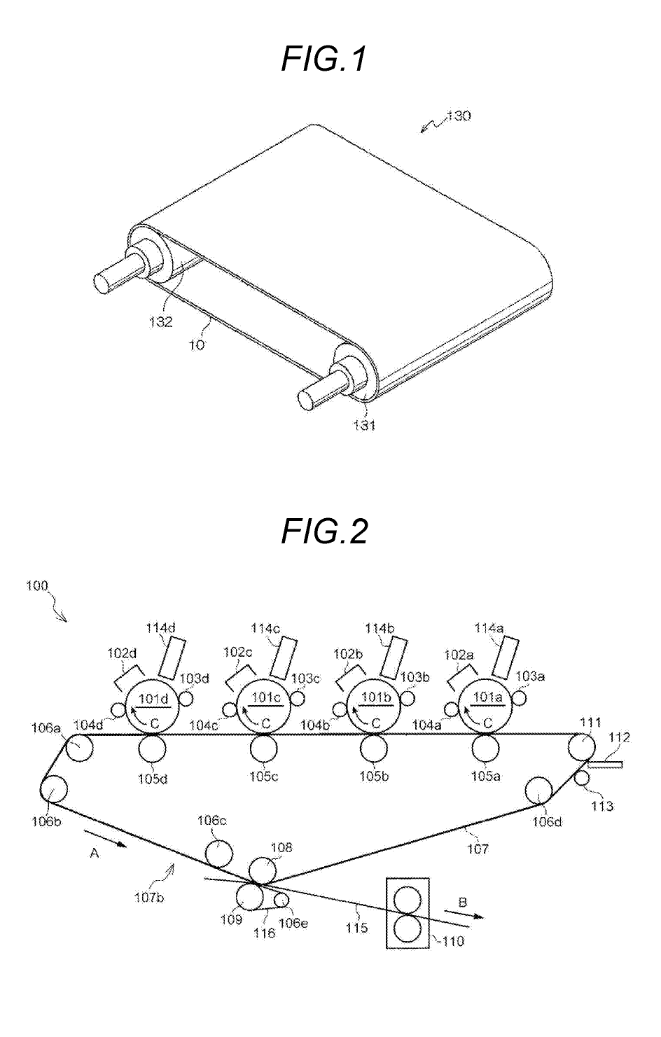

FIG. 1 is a schematic perspective view showing an example of the belt unit according to the exemplary embodiment. As shown in FIG. 1, a belt unit 130 according to the exemplary embodiment includes an endless belt 10 according to the exemplary embodiment, and the endless belt 10 is, for example, supported by a driving roll 131 and a driven roll 132 disposed to oppose each other in a state where tension is applied.

Here, in a case where the endless belt 10 is used as an intermediate transfer body, a roll for performing primary transfer of a toner image on a surface of a photoreceptor (image holding member) onto the endless belt 10 and a roll for performing secondary transfer of the toner image transferred onto the endless belt 10 to a recording medium may be disposed in the belt unit 130 according to the exemplary embodiment, as rolls supporting the endless belt 10.

The number of rolls supporting the endless belt 10 is not limited and the rolls may be disposed according to a usage mode. The belt unit 130 having the configuration described above is incorporated and used in an apparatus, and the endless belt 10 is also rotated in a supported state according to the rotation of the driving roll 131 and the driven roll 132.

Image Forming Apparatus

An image forming apparatus according to the exemplary embodiment includes an image holding member, a charging device which charges a surface of the image holding member, a latent image forming device which forms a latent image on the charged surface of the image holding member, a developing device which develops a latent image on the surface of the image holding member with a developer containing toner to form a toner image, an intermediate transfer belt which is the endless belt according to the exemplary embodiment, a primary transfer device which performs primary transfer of the toner image formed on the surface of the image holding member to an outer circumferential surface of the intermediate transfer belt, and a secondary transfer device which performs secondary transfer of the toner image transferred to the outer circumferential surface of the intermediate transfer belt to a recording medium.

As the image forming apparatus according to the exemplary embodiment, a color image forming apparatus which repeats primary transfer of a toner image held on an image holding member to an intermediate transfer belt, and a tandem type color image forming apparatus in which plural image holding members including a developing device of each color are disposed on an intermediate transfer belt in series, is used.

Hereinafter, the image forming apparatus according to the exemplary embodiment will be described with reference to the drawings.

FIG. 2 is a schematic configuration diagram showing an example of the image forming apparatus according to the exemplary embodiment. The image forming apparatus shown in FIG. 2 is an image forming apparatus in which the endless belt according to the exemplary embodiment is used as the intermediate transfer belt.

As shown in FIG. 2, an image forming apparatus 100 according to the exemplary embodiment is, for example, a so-called tandem type, and charging devices 102a to 102d, exposure devices 114a to 114d, developing devices 103a to 103d, primary transfer devices (primary transfer rolls) 105a to 105d, and image holding member cleaning devices 104a to 104d are sequentially disposed around four image holding members 101a to 101d formed of electrophotographic photoreceptors along a rotation direction thereof. In addition, an erasing device may be provided in order to erase residual potential remaining on the surfaces of the transferred image holding members 101a to 101d.

The intermediate transfer belt 107 is supported by support rolls 106a to 106d, a driving roll 111, and a facing roll 108 while applying tension and a transfer unit 107b is formed. The intermediate transfer belt 107 contacts with the surfaces of the image holding members 101a to 101d by using the support rolls 106a to 106d, the driving roll 111, and the facing roll 108, and moves the image holding members 101a to 101d and the primary transfer roll 105a to 105d in an arrow A direction. Some parts of the primary transfer rolls 105a to 105d which contact with the image holding members 101a to 101d through the intermediate transfer belt 107 become primary transfer parts, and a primary transfer voltage is applied to the contact parts of the image holding members 101a to 101d and the primary transfer rolls 105a to 105d.

The facing roll 108 and the secondary transfer roll 109 are disposed to oppose each other through the intermediate transfer belt 107 and a secondary transfer belt 116 as the secondary transfer device. The secondary transfer belt 116 is supported by the secondary transfer roll 109 and a support roll 106e. A recording medium 115 such as paper contacts with the surface of the intermediate transfer belt 107, and an area thereof interposed between the intermediate transfer belt 107 and the secondary transfer roll 109 in an arrow B direction and then passes through a fixing device 110. A part of the secondary transfer roll 109 which contacts with facing roll 108 through the intermediate transfer belt 107 and the secondary transfer belt 116 becomes a secondary transfer part, and a secondary transfer voltage is applied to the contact part between the secondary transfer roll 109 and the facing roll 108. Intermediate transfer belt cleaning devices 112 and 113 are disposed so as to contact with the intermediate transfer belt 107 after transfer.

Image Holding Member

As the image holding members 101a to 101d, a well-known electrophotographic photoreceptor is widely used. As an electrophotographic photoreceptor, an inorganic photoreceptor in which a sensitive layer is configured with an inorganic material or an organic photoreceptor in which a photosensitive layer is configured with an organic material is used. In the organic photoreceptor, a function separation type organic photoreceptor in which a charge generation layer which generates charges due to exposure and a charge transport layer which transports charges are laminated, or a single-layer type organic photoreceptor having a function of generating charges and a function of transporting charges is suitably used. In the inorganic photoreceptor, a photoreceptor in which a photosensitive layer is configured with amorphous silicon is suitably used.

The shape of the image holding member is not particularly limited, and well-known shapes such as a cylindrical drum shape, a sheet shape, and a plate shape are used, for example.

Charging Device

The charging devices 102a to 102d are not particularly limited, and well-known chargers such as a contact-type charger using a conductive (here, “conductive” of the charging device means that volume resistivity is less than 10⁷ Ω·cm) or a semiconductor (here, “semiconductor” of the charging device means that volume resistivity is from 10⁷ to 10¹³ Ω·cm) roller, a flange, a film, or a rubber blade, and a scorotron charger or a corotron charger using corona discharge are widely used. Among these, the contact-type charger is preferable.

The charging devices 102a to 102d normally apply direct current to the image holding members 101a to 101d, but may further apply current by superimposing alternating current.

Exposure Device

The exposure devices 114a to 114d are not particularly limited, and well-known exposure devices such as light sources such as semiconductor laser beam, light emitting diode (LED) light, and liquid crystal shutter light, or an optical device which may expose light in a determined image pattern through a polygon mirror from these light sources are widely used on the surface of the image holding members 101a to 101d.

Developing Device

The developing devices 103a to 103d are selected according to the purpose, and for example, well-known developing devices which develops a single-component developer or a two-component developer in a contact or non-contact manner using a brush or a roller are used.

Primary Transfer Roll

The primary transfer rolls 105a to 105d may be one of a single layer or plural layers. For example, in a case of a single-layer structure, the primary transfer rolls are configured with rolls in which a suitable amount of conductive particles such as carbon black is blended with foaming or non-foaming silicone rubber, urethane, or EPDM.

Image Holding Member Cleaning Device

The image holding member cleaning devices 104a to 104d are for removing residual toner attached to the surfaces of the image holding members 101a to 101d after the primary transfer process, and brush cleaning or roll cleaning is used, in addition to cleaning blade. Among these, cleaning blade is preferably used. In addition, as the material of the cleaning blade, urethane rubber, neoprene rubber, or silicone rubber is used.

Secondary Transfer Roll

The layer structure of the secondary transfer roll 109 is not particularly limited, and for example, in a case of a three-layer structure, the secondary transfer roll is configured with a core layer, an intermediate layer, and a coating layer coating the surface thereof The core layer is configured with a foam body of silicone rubber, urethane rubber, or EPDM in which conductive particles are dispersed, and the intermediate layer is configured with a non-foam body thereof. As the material of the coating layer, a tetrafluoroethylene-hexafluoropropylene copolymer, or a perfluoroalkoxy resin is used. The volume resistivity of the secondary transfer roll 109 is preferably equal to or smaller than 10⁷ Ωcm. The secondary transfer roll may have a two-layer structure without the intermediate layer.

Facing Roll

The facing roll 108 is formed as an opposing electrode of the secondary transfer roll 109. The layer structure of the facing roll 108 may be one of a single layer or plural layers. For example, in a case of a single-layer structure, the facing roll is configured with a roll in which a suitable amount of conductive particles such as carbon black is blended with silicone rubber, urethane, or EPDM. In a case of a two-layer structure, the facing roll is configured with a roll in which an outer circumferential surface of an elastic layer configured with the rubber material described above is coated with a high-resistivity layer.

A voltage of 1 kV to 6 kV is normally applied to the cores of the facing roll 108 and the secondary transfer roll 109. Instead of applying a voltage to the core of the facing roll 108, a voltage may be applied to an electrode member having excellent electrical conductivity, which contacts with the facing roll 108, and the secondary transfer roll 109. As the electrode member, a metal roll, a conductive rubber roll, a conductive brush, a metal plate, or a conductive resin plate is used.

Fixing Device

As the fixing device 110, well-known fixing machines such as a heat roller fixing machine, a pressure roller fixing machine, or a flash fixing machine are widely used, for example.

Intermediate Transfer Belt Cleaning Device

As the intermediate transfer belt cleaning devices 112 and 113, brush cleaning or roll cleaning is used, in addition to the cleaning blade, and among these, the cleaning blade is preferably used. In addition, as the material of the cleaning blade, urethane rubber, neoprene rubber, or silicone rubber is used.

In the multicolor image forming apparatus 100 having this configuration, the image holding member 101a rotates in an arrow C direction, the surface thereof is charged by the charging device 102a, and then, an electrostatic latent image having a first color is formed by the exposure device 114a such as laser beam. The formed electrostatic latent image is charged (image forming) with a developer containing toner by using the developing device 103a containing toner corresponding to the color, to form a toner image. A toner corresponding to the electrostatic latent image of each color (for example, yellow, magenta, cyan, and black) is respectively contained in the developing devices 103a to 103d.

When passing through the primary transfer parts, the toner image formed on the image holding member 101a is electrostatically transferred (primary transfer) onto the intermediate transfer belt 107 by the primary transfer roll 105a. Hereinafter, the toner images having the second color, the third color, and the fourth color are primarily transferred onto the intermediate transfer belt 107 holding the toner image having the first color by using the primary transfer rolls 105b to 105d so that the toner images are sequentially overlapped, and a superimposed toner image having multi colors is finally obtained.

When passing through the secondary transfer parts, the superimposed toner image formed on the intermediate transfer belt 107 is collectively electrostatically transferred to the recording medium 115. The recording medium 115 to which the toner image is transferred is transported to the fixing device 110, and subjected to a fixing treatment by heating and pressurizing, or heating or pressurizing, then discharged to the outside of the apparatus.

The residual toner of the image holding members 101a to 101d after the primary transfer is removed by the image holding member cleaning devices 104a to 104d. Meanwhile, the residual toner of the intermediate transfer belt 107 after the secondary transfer is removed by the intermediate transfer belt cleaning devices 112 and 113, and the residual toner of the intermediate transfer belt is prepared for the next image forming process.

### EXAMPLES

Hereinafter, the exemplary embodiment of the invention will be described in detail using examples, but the exemplary embodiment of the invention is not limited to the examples. Hereinafter, “part” is based on weight, unless otherwise noted.

### Examples 1 to 5 and Comparative Examples 1 to 3

A resin and carbon black (referred to as CB) are mixed with a composition 1 (numerical value is the number of parts) shown in Table 1 by using a HENSCHEL MIXER (FM10C manufactured by Nippon Coke & Engineering. Co., Ltd.). A mixture obtained by melting and kneading the mixed composition by using a twin screw extrusion kneader (L/D60 (Parker Corporation)) at a milling temperature shown in Table 1 is extruded in a string shape by a hole having a size of φ5, and cooled and solidified in a water tank. Then, the cooled and solidified string-shaped material is inserted into a pelletizer, is cut with a cut size having a length of approximately 5 mm, and a CB-containing resin pellet is obtained.

Next, the CB-containing resin pellet and a resin are mixed with a composition 2 (numerical value is the number of parts) shown in Table 1 by using HENSCHEL MIXER (FM10C manufactured by Nippon Coke & Engineering. Co., Ltd.). The mixed composition A is put into a single screw melt extruder (L/D24, melt extruder (manufactured by Mitsuba MFG Co., Ltd.)) set at an extruding temperature (formation temperature) shown in Table 1 and is extruded in a cylindrical shape from a gap between a cyclic die and a nipple while being melted. After bringing the inner peripheral surface of the extruded cylindrical melted resin in contact with a die for cooling (temperature of 80° C.) to cool the resin, the resultant material is cut to have a target width by using a cutting device, and an endless belt having an outer diameter of φ160×232× approximately 100 μm is obtained.

In a comparative example, without mixing the composition 2, the CB-containing resin pellet (corresponding to composition A) of the composition 1 shown in Table 1 is put into the single screw melt extruder to obtain an endless belt.

Evaluation

The following evaluation is performed with respect to the endless belt obtained in each example. The results are shown in Table 1.

Confirmation of Sea-Island Structure

A small piece-shaped sample is cut from the endless belt obtained in each example, and embedded and solidified in a resin for electron microscope, and a sample sectional block is prepared by using a microtome. A material obtained by vapor deposition of Pt onto this sectional surface is observed by using FE-SEM (JSM-6700F manufactured by JEOL, Ltd., accelerating voltage: 5 kV/10 kV). Accordingly, presence or absence of the sea-island structure is confirmed. In a case of the sea-island structure, the presence of carbon black in the island part is not confirmed and the presence of carbon black in the sea part is confirmed.

Viscosity

The viscosity of the “composition A” used for obtaining the endless belt of each example is measured under the conditions of a measurement temperature of 300° C. and a shear velocity of 10 sec⁻¹.

Compressive Elasticity Modulus/Bending Resistance

The compressive elasticity modulus and the bending resistance of the endless belt obtained in each example are measured by using the method described above.

Foam Breaking Marks

The endless belt obtained in each example is visually observed, and with respect to the portion having a size of 1 cm×1 cm, the foam breaking marks are evaluated based on the following evaluation criteria.

Evaluation Criteria

A: the number of foam breaking marks is equal to or smaller than 10

B: the number of foam breaking marks is from 11 to 20

C: the number of foam breaking marks is equal to or greater than 21

Initial Cleaning Properties

The endless belt obtained in each example is mounted on an image forming apparatus “DocuPrint CP400D manufactured by Fuji Xerox Co., Ltd.” as the intermediate transfer belt, 50 sheets of lattice images having image density of 8% are continuously printed on A4-sized paper in the environment of a temperature of 18° C. and humidity of 40% RH, and then, the evaluation of initial cleaning properties of the halftone (magenta of 30%) image is performed according to the following evaluation criteria.

Evaluation Criteria

A: no generation of deletion due to cleaning failure

B: slight generation of deletion due to cleaning failure (acceptable level)

C: significant generation of deletion due to cleaning failure (not acceptable level)

Cleaning Maintaining Properties

In the evaluation of the initial cleaning properties, 5000 sheets of images are further printed, and then, the evaluation of cleaning maintaining properties is performed with respect to the halftone (magenta 30%) images according to the above evaluation criteria.

TABLE 1

| | | | | | Comparative | Comparative | Comparative | Comparative | Comparative |
|---|---|---|---|---|---|---|---|---|---|
| | | Example 1 | Example 2 | Example 3 | Example 1 | Example 2 | Example 3 | Example 4 | Example 5 |
| Composition | PEI(Ultem1010) | 70 | 45 | 40 | 40 | | 60 | 5 | 70 |
| 1 | PEI(Ultem1040A) | 30 | 25 | 30 | 40 | 35 | 20 | 25 | 20 |
| | Si-PEI(Sltem1500) | | | | 20 | | 10 | | |
| | Si-PEI(Sltem1700) | | | | | 65 | | | |
| | PBN(IQB-OT) | | | 30 | | | | | 10 |
| | PE-Elastomer | | 30 | | | | | | |
| | HYTREL 7277 | | | | | | | | |
| | PEN (TEONEX | | | | | | 10 | 70 | |
| | TN8065S) | | | | | | | | |
| | CB(Pritex-α) | 23 | 23 | | 23 | | 23 | | 20 |
| | CB(Vulcan9A32) | | | 20 | | 20 | | 20 | |
| Melt flow rate of PEI of composition | | 15 | 16 | 20 | 23 | 35 | 11 | 32 | 9 |
| 1 (g/10 min) | | | | | | | | | |
| Composition | Si-PEI(Sltem1500) | 10 | 10 | | | | | 20 | |
| 2 | Si-PEI(Sltem1700) | | | 10 | | | | | 10 |
| | Extrusion temperature | 310 | 290 | 290 | 310 | 290 | 330 | 290 | 340 |
| | (° C.) | | | | | | | | |
| Evaluation | Presence or absence of | Present | Present | Present | Absent | Absent | Absent | Present | Present |
| | sea-island structure | | | | | | | | |
| | Viscosity (Pa · s) | 6500 | 7000 | 6000 | 13000 | 3000 | 9700 | 4000 | 8500 |
| | Compressive elasticity | 3200 | 3500 | 3000 | 3300 | 2400 | 2500 | 3000 | 3500 |
| | modulus (MPa) | | | | | | | | |
| | Bending resistance | 300 | 450 | 400 | 230 | 850 | 150 | 600 | 140 |
| | (times) | | | | | | | | |
| | Foam breaking marks | A | A | A | C | C | C | A | B |
| | Initial toner cleaning | A | A | A | C | C | C | A | B |
| | properties | | | | | | | | |
| | Cleaning maintaining | A | A | A | C | C | C | A | B |
| | properties | | | | | | | | |

From the results, it is found that, in the endless belt of this example, generation of foam breaking marks is prevented, compared to the endless belt of the comparative example 1. It is also found that the endless belt of this example has excellent compressive elasticity modulus and bending resistance. In addition, it is also found that initial cleaning properties and cleaning maintaining properties are excellent.

Particularly, it is found that the endless belt of the example 2 using polyester and polyester elastomer has improved bending resistance.

When the confirmation is performed regarding the foam breaking marks in detail, it is found that generation of foam breaking marks is prevented in the example 3, compared to the example 1 or the example 2, and generation of foam breaking marks is prevented in the example 4, compared to example 3.

In a case where one kind of polyetherimide (PEI) is used, the “melt flow rate of PEI of the composition 1” shown in Table 1 shows a melt flow rate of the one kind of PEI, and in a case where two kinds of PEI are used, the melt flow rate shows a melt flow rate of the PEI obtained by mixing the two kinds thereof.

Details of the materials in Table 1 are as follows.

PEI (Ultem 1010): polyetherimide “Ultem 1010 (Saudi Basic Industries Corporation (SABIC))”

PEI (Ultem 1040A): polyetherimide “Ultem 1040A (Saudi Basic Industries Corporation (SABIC))”

Si-PEI (Sltem 1500): silicone-modified polyetherimide “Sltem 1500 (Saudi Basic Industries Corporation (SABIC))”

Si-PEI (Sltem 1700): silicone-modified polyetherimide “Sltem 1700 (Saudi Basic Industries Corporation (SABIC))”

PBN (IQB-OT): polyester (polybutylene naphthalate “IQB-OT (Teijin Limited)”)

PE (PE-Elastomer: HYTREL 7277): polyester (polyester elastomer “HYTREL 7277 (Du Pont-Toray Co., Ltd.)”)

PEN (TEONEX TN8065S): polyester (polyethylene naphthalate “TEONEX TN8065S (Teijin Limited)”)

CB (Pritex-α): carbon black “Pritex-α (Degussa)”

CB (Vulcan 9A32): carbon black “Vulcan 9A32 (Cabot Corporation)”

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An endless belt for an image forming apparatus comprising:
a resin layer having a sea-island structure including an island part containing a silicone-modified polyetherimide and a sea part containing a polyetherimide other than the silicone-modified polyetherimide and containing carbon black.

2. The endless belt according to claim 1,
wherein the sea part contains a polyester.

3. The endless belt according to claim 2,
wherein the polyester is at least one of polyalkylene naphthalate and a polyester elastomer.

4. The endless belt according to claim 1,
wherein a melt flow rate of the polyetherimide other than the silicone-modified polyetherimide is equal to or greater than 15 g/10 min.

5. The endless belt according to claim 2,
wherein a melt flow rate of the polyetherimide other than the silicone-modified polyetherimide is equal to or greater than 15 g/10 min.

6. The endless belt according to claim 3,
wherein a melt flow rate of the polyetherimide other than the silicone-modified polyetherimide is equal to or greater than 15 g/10 min.

7. A belt unit for an image forming apparatus comprising:
the endless belt according to claim 1; and
a plurality of rolls that support the endless belt in a state that tension is applied.

8. An image forming apparatus comprising:
an image holding member;
a charging device that charges a surface of the image holding member;
a latent image forming device that forms a latent image on the charged surface of the image holding member;
a developing device that develops a latent image on the surface of the image holding member with a developer containing toner so as to form a toner image;
an intermediate transfer belt that is the endless belt according to claim 1;
a primary transfer device that performs primary transfer of the toner image formed on the surface of the image holding member to an outer circumferential surface of the intermediate transfer belt; and
a secondary transfer device that performs secondary transfer of the toner image transferred to the outer circumferential surface of the intermediate transfer belt to a recording medium.

9. A resin composition comprising:
a sea-island structure including an island part containing a silicone-modified polyetherimide and a sea part containing a polyetherimide other than the silicone-modified polyetherimide and containing carbon black.

10. A manufacturing method of an endless belt for an image forming apparatus comprising:
forming a resin layer having a sea-island structure including an island part containing a silicone-modified polyetherimide and a sea part containing a polyetherimide other than the silicone-modified polyetherimide and containing carbon black.

11. A manufacturing method of a resin composition comprising
forming a sea-island structure including an island part containing a silicone-modified polyetherimide and a sea part containing a polyetherimide other than the silicone-modified polyetherimide and containing carbon black.
